(19) United States
(12) Patent Application Publication
(10) Pub. No.: US 2024/0409077 A1
(43) Pub. Date: Dec. 12, 2024

(54) HYDRAULIC BRAKE SYSTEM AND METHOD FOR OPERATING A BRAKE SYSTEM

(71) Applicant: Robert Bosch GmbH, Stuttgart (DE)

(72) Inventors: Herbert Vollert, Vaihingen/Enz (DE); Martin Marquart, Reichenbach (DE); Willi Nagel, Remseck/Hochdorf (DE)

(21) Appl. No.: 18/695,267

(22) PCT Filed: Dec. 5, 2022
(86) PCT No.: PCT/EP2022/084386

§ 371 Date: Mar. 25, 2024

(30) Foreign Application Priority Data
Dec. 23, 2021 (DE) 10 2021 215 002.0

(51) Int. Cl. B60T 13/66; B60T 13/74; B60T 17/22

(52) U.S. Cl. CPC B60T 13/662; B60T 13/745; B60T 17/22

(57) ABSTRACT

A hydraulic brake system, in particular a hydraulic brake system for a motor vehicle. The control of a master brake cylinder to build up the hydraulic pressure is effected exclusively by an electric drive. The setpoint specification for controlling the electromechanical drive can be received as an electrical signal. In the event of a fault, redundant brake pressure generation can be ensured by using a brake pressure generation device of a vehicle dynamics control system.

### FIELD

The present invention relates to a hydraulic brake system and to a method for operating a hydraulic brake system.

### BACKGROUND INFORMATION

Vehicles, in particular motor vehicles, typically comprise a brake system that is capable of safely slowing a moving vehicle to a standstill. Hydraulic brake systems, in particular, are used for this purpose. When actuating the brake, a user can be assisted by a brake booster, for example a vacuum brake booster or an electromechanical brake booster. Assistance systems such as an anti-lock braking system (ABS) or an electronic stability program (ESP), which can actively influence the braking behavior of a vehicle, are used as well.

German Patent Application No. DE 10 2012 205 861 A1, for example, describes a hydraulic brake system comprising a master brake cylinder, two brake pressure generators, at least one wheel brake cylinder as well as interruption means for redundant brake pressure generation and brake pressure control with electrical support.

### SUMMARY

The present invention creates a hydraulic brake system for a vehicle, a motor vehicle comprising such a hydraulic brake system and a method for operating a brake system. Advantageous embodiments of the present invention are disclosed herein.

Provided according to an example embodiment of the present invention is:

A hydraulic brake system for a vehicle comprising a pressure build-up device and a vehicle dynamics control. The pressure build-up device includes an input interface, a master brake cylinder and an electromechanical drive. The input interface of the pressure build-up device is configured to receive an electronic setpoint specification from an external setpoint generator. The master brake cylinder is configured to build up hydraulic pressure in at least two independent brake circuits. The electromechanical drive is configured to actuate the master brake cylinder. The electromechanical drive is in particular configured to actuate the master brake cylinder using the setpoint specification received through the input interface. The master brake cylinder can hereby be actuated exclusively by the electromechanical drive. In other words, no actuating element, by means of which the master brake cylinder can be actuated via a mechanical connection by an external mechanical actuating element, for example a brake pedal, is provided. The vehicle dynamics control comprises a brake pressure generation device. The brake pressure generation device is configured to build up hydraulic pressure in the at least two independent brake circuits. The hydraulic pressure in the two independent brake circuits can therefore be built up on the one hand by the master brake cylinder and on the other hand by the brake pressure generation device.

Provided according to an example embodiment of the present invention is:

A motor vehicle comprising a hydraulic brake system according to the present invention.

Provided according to an example embodiment of the present invention is also:

A method for operating a brake system, in particular a hydraulic brake system according to the present invention, comprising a step of receiving an electronic setpoint specification at the input interface of the pressure build-up device and a step of controlling the electromechanical drive according to the received setpoint specification.

The present invention is based on the realization that conventional brake systems, in particular hydraulic brake systems, are typically controlled by an external mechanical actuating element via a mechanical connection. This external actuating element can be the brake pedal of a motor vehicle, for instance, that is coupled to the master brake cylinder of a brake system via a mechanical connection. This control can be supported by a brake booster if necessary. However, in all cases an external mechanical force, for example from the brake pedal, is transmitted to the master brake cylinder.

One idea of the present invention is to replace the mechanical transmission of force, for example from a brake pedal to the master brake cylinder, with an electronic signal transmission and an electromechanical actuating element on the master brake cylinder. Elaborate, complex and possibly error-prone mechanical force transmissions from a brake pedal to the master brake cylinder can thus be avoided and replaced by a simple and flexible electronic signal transmission.

The use of two independent components to provide the hydraulic pressure in the brake circuits ensures that sufficient hydraulic pressure can be built up in the brake circuits to actuate the brake system even if a component for building up the hydraulic pressure fails. The hydraulic brake system of an example embodiment of the present invention thus firstly comprises a plurality of independent hydraulic brake circuits, so that, if one hydraulic brake circuit is defective, the remaining hydraulic brake circuits(s) can still decelerate the vehicle. The use of two independent components, that are both capable of building up hydraulic pressure in the brake circuits, also ensures that, even if one component fails to build up hydraulic pressure, the respective other component can still build up sufficient hydraulic pressure to decelerate the vehicle. This makes it possible to realize a hydraulic brake system that ensures the necessary redundancy and thus safety in the brake system. There is expressly no need here for a mechanical connection between an actuating element for a user, for example a brake pedal, and the brake system. In other words, the setpoint specification for building up hydraulic pressure in the brake system is achieved exclusively by providing electronic signals.

The electronic signal for transmitting the setpoint specification to the brake system can be generated, transmitted and provided to the brake system in any manner. The signal can be transmitted as a digital signal via a suitable communication bus, for instance, for example a CAN bus or the like. The electronic signal can moreover also be provided in the form of a voltage or current signal. In principle, it is also possible to provide the signal as an optical signal, for example, and convert it into an electronic signal at the input interface of the brake system by means of an appropriate converter.

According to an example embodiment of the present invention, the signal for the setpoint specification can be provided by a setpoint generator, for example a sensor on a brake pedal or the like. A user can thus use a suitable input device, for example the brake pedal, to specify a setpoint which is provided as an electronic signal to the brake system via a communication link. Hydraulic pressure can then be built up in the brake circuits of the brake system in accordance with the setpoint specification specified by the user.

According to one example embodiment of the present invention, the vehicle dynamics control comprises an electronic stability program (ESP). A component for building up hydraulic pressure in such an ESP can therefore be used to nonetheless build up hydraulic pressure in the brake circuits of the brake system, for example in the event of a malfunction of the pressure build-up device, with the master brake cylinder. This could also include providing the setpoint specification to the vehicle dynamics control in order to build up the desired hydraulic pressure through the vehicle dynamics control in the event of a defect in the pressure build-up device.

According to one example embodiment of the present invention, the brake pressure generation device of the vehicle dynamics control is configured to build up hydraulic pressure in the at least two independent brake circuits if a malfunction in the pressure build-up device has been detected. The vehicle dynamics control can therefore provide the hydraulic pressure required to actuate the brake system, even if the pressure build-up device is unable to provide sufficient hydraulic pressure. Thus, the two independently acting components, the pressure build-up device with the master brake cylinder on the one hand and the vehicle dynamics control with the brake pressure generation device on the other hand, provide a redundant system for building up hydraulic pressure in the brake circuits.

According to one example embodiment of the present invention, the brake system comprises a setpoint generator. The setpoint generator is configured to provide an electronic setpoint specification corresponding to a user input at the input interface of the pressure build-up device. The setpoint generator can, for instance, provide a variable corresponding to a position of a brake pedal. This variable can be provided as an analog or digital signal as a setpoint specification at the pressure build-up device. In addition to the setpoint generator, which can detect a position of a brake pedal and provide a corresponding output signal, a feedback device can be provided on the brake pedal as well. Such a feedback device can provide haptic feedback on the brake pedal in the form of a force, vibration or the like, for example. A user can thus be given feedback about the braking behavior.

According to one example embodiment of the present invention, the setpoint generator is mechanically coupled to a brake pedal of the vehicle. The setpoint generator is also electrically or optically coupled to the input interface of the pressure build-up device. The variable specified by the user by actuating the brake pedal can thus be provided as an electrical or optical signal at the input interface of the brake system. A mechanical coupling of the brake pedal to the brake system can thus be eliminated entirely.

According to one example embodiment of the present invention, the setpoint specified by the setpoint generator can be provided as a digital data signal at the input interface of the brake system. The variable acquired by the setpoint generator can be transmitted to the input interface of the brake system via a data bus, for instance, for example a CAN bus or the like.

According to one example embodiment of the present invention, the pressure build-up device is configured to be powered by a first power supply system. The vehicle dynamics control is furthermore configured to be powered by a second power supply system. In other words, the pressure build-up device and the vehicle dynamics control are powered by two separate, in particular two independent, power supply systems or power sources. This makes it possible to ensure that sufficient hydraulic pressure can be provided to actuate the brake system even if one of the two power supply systems fails.

The above configurations and further developments can be combined with one another in any desired manner if useful. Further configurations, developments and implementations of the present invention also include not explicitly mentioned combinations of features of the present invention described above or in the following with respect to the design examples.

Those skilled in the art will in particular also add individual aspects as improvements or additions to the respective basic forms of the present invention.

### BRIEF DESCRIPTION OF THE DRAWINGS

Further features and advantages of the present invention are explained in the following with reference to the figures.

FIG. 1 shows a schematic illustration of a block diagram of a hydraulic brake system according to one example embodiment of the present invention.

FIG. 2 shows a schematic illustration of a block diagram of a hydraulic brake system according to another example embodiment of the present invention.

FIG. 3 shows a flowchart as it forms the basis for a method for operating a brake system according to one example embodiment of the present invention.

In the figures, the same reference signs refer to the same or functionally identical components unless stated otherwise.

### DETAILED DESCRIPTION OF EXAMPLE EMBODIMENTS

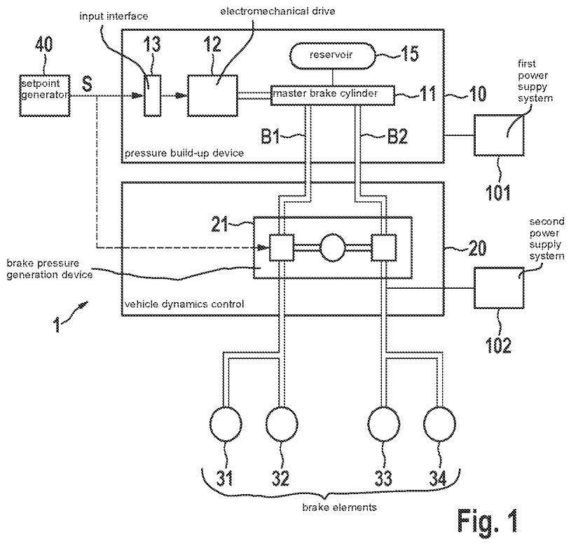

FIG. 1 shows a schematic view of a block diagram to illustrate the basic principle of a hydraulic brake system 1 for a vehicle according to an embodiment. The brake system shown here comprises a pressure build-up device 10 and a vehicle dynamics control 20. The pressure build-up device 10 comprises a master brake cylinder 11. This master brake cylinder 11 can comprise a plurality of chambers 11a, 11b, wherein each chamber 11a, 11b is connected to a separate independent brake circuit B1, B2. Hydraulic pressure can thus be built up by the master brake cylinder 11 in the plurality of independent brake circuits B1, B2 by actuating the master brake cylinder. The plurality of brake circuits B1, B2 are not connected to one another. The plurality of brake circuits B1, B2 are therefore independent brake circuits. Therefore, in the event of a malfunction, for example due to a leak, in one of the brake circuits B1, B2, hydraulic pressure can continue to be built up in the remaining brake circuits B1, B2.

An electromechanical drive 12 is provided for actuating the master brake cylinder 11. It is in particular provided that the master brake cylinder 11 is actuated exclusively by this electromechanical drive 12. In other words, there is no mechanical coupling of the master brake cylinder to a mechanical actuating element, such as a brake pedal or the like.

The electromechanical drive 12 can in principle be any suitable electromechanical drive, such as an electric motor with a transmission. The electromechanical drive can in particular be controlled such that a corresponding hydraulic pressure is built up in the brake circuits B1 and B2 by actuating the master brake cylinder 11 in accordance with a setpoint specification received via an input interface 13. An electromechanical drive 12 can be used to actuate the master brake cylinder 11, for instance, as is the case in the same or a similar manner for electromechanical brake boosters in conventional brake systems. According to the present invention, however, the conventional mechanical actuation by transmitting a force from the brake pedal to the master brake cylinder is omitted. The master brake cylinder is instead actuated exclusively by the electromechanical drive 12 in accordance with the received setpoint specification S.

The setpoint specification S can be received as an analog or digital signal by the input interface 13. An electric voltage corresponding to a setpoint specification or a corresponding electric current can be provided at the input interface 13, for example. However, it is also possible to provide a digital signal at the input interface 13, for instance, for example a pulse-width modulated signal. The setpoint specification S can moreover also be provided at the input interface 13 as digital information via a communication link, for example a data bus, such as a CAN bus or the like. The setpoint specification S can in particular be provided as an analog or digital electrical signal at the input interface 13. In addition, however, it is also possible to transmit the setpoint specification as an optical signal, for example, and to convert the optical signal into an electrical signal by means of an appropriate converter at the input interface 13 and make it available for further processing.

The setpoint specification S can be provided by a setpoint generator 40, for example. This setpoint generator 40 can be a sensor, for example, which provides an output signal that corresponds to a position of a brake pedal or a force applied to the brake pedal. For this purpose, the setpoint generator can be mechanically coupled to the brake pedal, for instance. The setpoint generator can also be connected to the input interface 13 via a communication link, for example an electrical or optical connection. Thus, a signal corresponding to the position of the brake pedal can be provided at the input interface 13 of the pressure build-up device 10. Additional components, which generate feedback on the brake pedal, for example in the form of resistance or vibration, can optionally be provided on the brake pedal as well. A user can thus be given haptic feedback about the braking behavior of the brake system. This makes it possible to simulate behavior for a user on the brake pedal that corresponds to behavior with a direct mechanical coupling between the brake pedal and the master brake cylinder.

The pressure build-up device 10 can thus actuate the master brake cylinder 11 using the setpoint provided by the setpoint generator 40 and corresponding control of the electromechanical drive 12. This builds up hydraulic pressure in each of the two independent brake circuits B1 and B2. This hydraulic pressure can, for instance, be used to actuate the brake elements 31 to 34. These brake elements 31 to 34 can include wheel brake cylinders on the wheels of a vehicle, for example.

In addition to the pressure build-up device 10, the brake system 1 also comprises a vehicle dynamics control 20. This vehicle dynamics control 20 can be the components of an electronic stability program (ESP), for example. The vehicle dynamics control 20 in particular comprises a brake pressure generation device 21. This brake pressure generation device 21 is configured to generate hydraulic pressure in the independent brake circuits B1 and B2. For each brake circuit B1 and B2, the brake pressure generation device 21 can comprise a hydraulic pump, for example, that can build up hydraulic pressure in the brake circuits B1 and B2. The brake pressure generation device 21 can in particular be an electrically operated brake pressure generation device.

Such a brake system 1 comprising a pressure build-up device 10 and also a vehicle dynamics control 20 comprising a further brake pressure generation device 21 provides two independent components for building up hydraulic pressure in the independent brake circuits B1 and B2. This provides sufficient redundancy to build up the hydraulic pressure required for braking in the brake circuits B1 and B2, even in the event of failure of one of the components, by means of the respective other component.

The pressure build-up device 10 comprising the input interface 13, the electromechanical drive 12 and the master brake cylinder 11 can be supplied with electrical power by a first power supply system 101, for example. The vehicle dynamics control 20 comprising the brake pressure generation device 21 can be supplied with electrical power by a further power supply system 102. The first power supply system 101 and the second power supply system 102 can in particular be independent of one another. A first electrical power store can be provided in the first power supply system 101, for instance, and a second electrical power store can be provided in the second power supply system 102. Thus, a redundant power supply is also available for the electrical power supply systems of the brake system 1 in the event of a failure of one of the two power supply systems 101 or 102 in order to supply electrical power to the components connected to it via the respective remaining power supply system 101 or 102, and thus be able to provide hydraulic pressure for decelerating the vehicle. The first power supply system 101 and the second power supply system 102 can be two independent low-voltage direct voltage networks of a motor vehicle, for instance. If necessary, the two power supply system 101 and 102 can be coupled to one another by means of a DC voltage converter. This makes it possible to realize an energy exchange for charging the electrical power stores in the power supply system 101 and 102. In addition, in particular in the case of fully or at least partially electrically driven vehicles, for example, the pressure build-up device 10 can also be powered directly by a traction battery of such an electric vehicle, while the vehicle dynamics control 20 is supplied with electrical power by a low-voltage network.

To be able to build up hydraulic pressure in accordance with the setpoint specification S in a controlled manner even in the event of a malfunction of the pressure build-up device 10, the setpoint specification S can also be additionally provided to the vehicle dynamics control 20 and in particular to the brake pressure generation device 21. In this case, if a malfunction of the pressure build-up device 10 is detected, the brake pressure generation device 21 of the vehicle dynamics control 20 can build up a brake pressure in the brake circuits B1 and B2 that corresponds to the setpoint specification S.

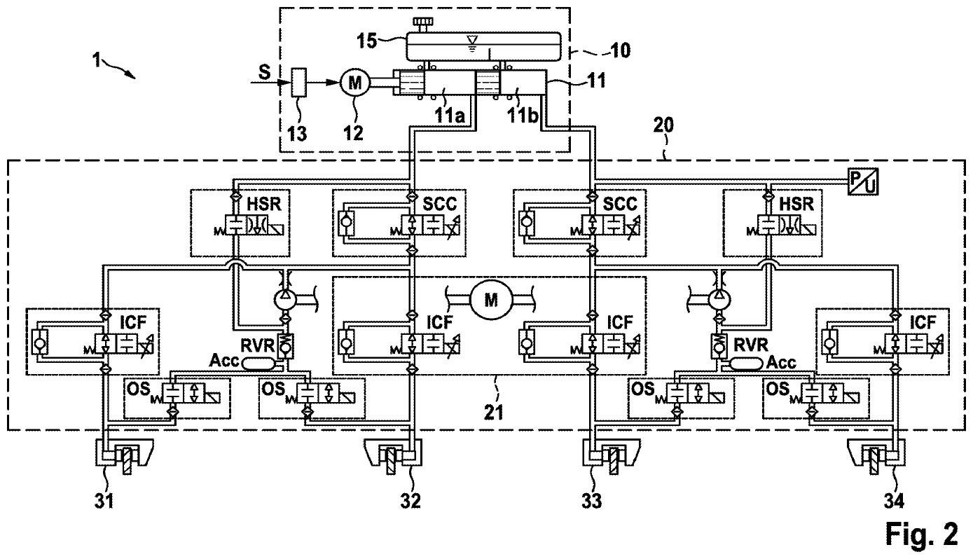

FIG. 2 shows a schematic illustration of a block diagram of a hydraulic brake system 1 according to one embodiment. The statements previously made in connection with FIG. 1 also apply to the brake system 1 shown in FIG. 2. FIG. 2 moreover shows the individual components of the pressure build-up device 10 and the vehicle dynamics control 20 in more detail.

As can be seen in FIG. 2, for example, the individual chambers 11a and 11b of the master brake cylinder 11 can be fed from a reservoir 15. In the idle state, i.e. when the master brake cylinder 11 is not actuated, a direct flow of brake fluid from the reservoir 15 through the chambers 11a and 11b of the master brake cylinder 11 into the brake circuits B1 and B2 is possible.

A device, which drives the piston of the master brake cylinder 11 to a position in the idle state in which such an unhindered flow of brake fluid from the reservoir 15 into the two independent brake circuits B1 and B2 is enabled, is preferably provided in the master brake cylinder 11. This can be achieved using spring force or the like, for instance. In the event of a malfunction or failure of the electromechanical drive 12, this makes it possible to ensure that brake fluid can flow from the reservoir 15 into the brake circuits B1 and B2 and thus that sufficient hydraulic pressure can be built up by the brake pressure generation device 21 of the vehicle dynamics control 20. The master brake cylinder 11 can furthermore also be configured such that a flow of hydraulic fluid from the reservoir 15 in the direction of the vehicle dynamics control 20 and in particular the brake pressure generation device 21 is possible even when the master brake cylinder 11 is actuated.

As already briefly mentioned above, the vehicle dynamics control 20 can be an electronic stability program (ESP) or the like. The individual components of such an ESP are shown schematically in FIG. 2. However, insofar as these are not the subject matter of the present invention, they are not explained in more detail here.

The vehicle dynamics control 20 and in particular the ESP include, among other components, a brake pressure generation device 21. This can be a hydraulic pump, for example, that can generate hydraulic pressure by means of an electric motor to actuate brake elements 31 to 34. The brake pressure generation device 21 of vehicle dynamics control 20 can in particular generate hydraulic pressure in each of independent brake circuits B1 and B2. Independent components for generating hydraulic pressure can be provided in the individual brake circuits B1 and B2 for this purpose. Alternatively, it is also possible that the pump components for building up the hydraulic pressure are controlled by a common electric drive as shown in FIG. 2.

The components for the brake pressure generation device 21 of the vehicle dynamics control 20 can generally be components such as those used in conventional vehicle dynamics controls, in particular, ESP. To increase redundancy for a fully electronically actuated brake system, the components for building up hydraulic pressure can moreover also be dimensioned accordingly if necessary.

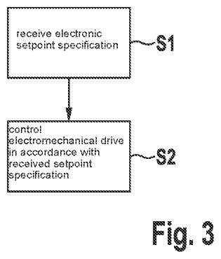

FIG. 3 shows a flowchart as it forms the basis for a method for operating a hydraulic brake system according to one embodiment. The brake system 1 being operated here can in particular be one of the hydraulic brake systems 1 described above.

In step S1, an electronic setpoint specification is received at the input interface 13 of the pressure build-up device 10.

Then, in step S2, the electromechanical drive 12 can be controlled in accordance with a received setpoint specification S.

If it is not possible to provide the hydraulic pressure required to actuate the brake system by means of the pressure build-up device 10 due to a failure or a malfunction, the hydraulic pressure can alternatively be built up by the brake pressure generation device 21 of the vehicle dynamics control 20. This ensures sufficient redundancy is given for safe operation of the hydraulic brake system in a vehicle.

In summary, the present invention relates to a hydraulic brake system, in particular a hydraulic brake system for a motor vehicle. The control of a master brake cylinder to build up the hydraulic pressure is effected exclusively by an electric drive. The setpoint specification for controlling the electromechanical drive can be received as an electrical signal. In the event of a fault, redundant brake pressure generation can be ensured by using a brake pressure generation device of a vehicle dynamics control system.

1-10. (canceled)

11. A hydraulic brake system for a vehicle, comprising:
a pressure build-up device; and
a vehicle dynamics control;
wherein the pressure build-up device includes:
an input interface which is configured to receive an electronic setpoint specification from an external setpoint generator,
a master brake cylinder which is configured to build up hydraulic pressure in at least two independent brake circuits, and
an electromechanical drive which is configured to actuate the master brake cylinder using the setpoint specification received through the input interface,
wherein the master brake cylinder can be actuated exclusively by the electromechanical drive,
wherein the vehicle dynamics control includes a brake pressure generation device which is configured to build up hydraulic pressure in the at least two independent brake circuits.

12. The brake system according to claim 11, wherein the vehicle dynamics control includes an electronic stability program.

13. The brake system according to claim 11, wherein the brake pressure generation device of the vehicle dynamics control s configured to build up hydraulic pressure in the at least two independent brake circuits when a malfunction in the pressure build-up device has been detected.

14. The brake system according to claim 11, further comprising
a setpoint generator configured to provide an electronic setpoint specification corresponding to a user input at the input interface of the pressure build-up device.

15. The brake system according to claim 14, wherein the setpoint generator is mechanically coupled to a brake pedal of the vehicle, and wherein the setpoint generator is electrically coupled to the input interface of the pressure build-up device.

16. The brake system according to claim 14, wherein the setpoint generator is coupled to the input interface of the pressure build-up device via a digital communication interface.

17. The brake system according to claim 11, wherein the pressure build-up device is configured to be powered by a first power supply system, and wherein the vehicle dynamics control is configured to be powered by a second power supply system.

18. A motor vehicle, comprising:
a hydraulic brake system, including:
a pressure build-up device; and
a vehicle dynamics control;
wherein the pressure build-up device includes:
an input interface which is configured to receive an electronic setpoint specification from an external setpoint generator,
a master brake cylinder which is configured to build up hydraulic pressure in at least two independent brake circuits, and
an electromechanical drive which is configured to actuate the master brake cylinder using the setpoint specification received through the input interface,
wherein the master brake cylinder can be actuated exclusively by the electromechanical drive,
wherein the vehicle dynamics control includes a brake pressure generation device which is configured to build up hydraulic pressure in the at least two independent brake circuits.

19. A method for operating a brake system, the brake system including:
a pressure build-up device; and
a vehicle dynamics control;
wherein the pressure build-up device includes:
an input interface which is configured to receive an electronic setpoint specification from an external setpoint generator,
a master brake cylinder which is configured to build up hydraulic pressure in at least two independent brake circuits, and
an electromechanical drive which is configured to actuate the master brake cylinder using the setpoint specification received through the input interface,
wherein the master brake cylinder can be actuated exclusively by the electromechanical drive,
wherein the vehicle dynamics control includes a brake pressure generation device which is configured to build up hydraulic pressure in the at least two independent brake circuits;
the method comprising the following steps:
receiving an electronic setpoint specification at the input interface of the pressure build-up device; and
controlling the electromechanical drive according to the received setpoint specification.

20. The method according to claim 19, further comprising:
building up hydraulic pressure in at least one of the brake circuits using the brake pressure generation device of the vehicle dynamics control when a malfunction in the pressure build-up device has been detected.
